(19) United States
(12) Patent Application Publication
(10) Pub. No.: US 2010/0269719 A1
(43) Pub. Date: Oct. 28, 2010

(54) Web-Fed Printing Press

(75) Inventors: Peter Schulmeister, Pfaffenhofen (DE); Wolfgang Ronecker, Ehingen (DE)

Correspondence Address: COHEN, PONTANI, LIEBERMAN & PAVANE LLP, 551 FIFTH AVENUE, SUITE 1210, NEW YORK, NY, 10176, US

(73) Assignee: manroland AG, Offenbach am Main (DE)

(21) Appl. No.: 12/743,334

(22) PCT Filed: Nov. 15, 2008
(86) PCT No.: PCT/EP2008/009680

§ 371 Date: Jun. 25, 2010

(30) Foreign Application Priority Data
Nov. 17, 2007 (DE) 10 2007 054 987.5

(51) Int. Cl. B41F 13/54

(52) U.S. Cl. 101/228

(57) ABSTRACT

A web-fed printing press having at least one printing unit for static printing of at least one printing substrate web, preferably of a plurality of printing substrate webs, with a printed image which is invariable for all printed copies, and at least one processing device positioned upstream of the folding apparatus and configured to dynamically process the at least one printing substrate web in a variable manner for at least some printed copies, and a manipulation device positioned to support the at least one processing device, where the at least one processing device is displaceable by the manipulation device in three spatial dimensions within a region of action of the manipulation device such that the at least one processing device is positionable at a freely definable position of the at least one printing substrate web with a freely definable orientation to the at least one printing substrate web.

### CROSS-REFERENCE TO RELATED APPLICATIONS

This is a U.S. national stage of International Application No. PCT/EP2008/009680, filed on 15 Nov. 2008. Priority is claimed on German Application No. 10 2007 054 987.5, filed on 17 Nov. 2007.

### BACKGROUND OF THE INVENTION

1. Field of the Invention

The invention is directed to a web-fed printing press having at least one printing unit for static printing of at least one printing substrate web, preferably of a plurality of printing substrate webs, with a printed image which is invariable for all printed copies, and comprising at least one processing device positioned upstream of a folding apparatus, preferably for dynamic processing of at least one printing substrate web in a variable manner for at least some printed copies.

2. Description of the Related Art

Web-fed printing presses have a plurality of printing units for printing on both sides of at least one printing substrate web, or of a plurality of printing substrate webs. In particular, the printing units are offset printing units. By using offset printing units, the printing substrate web, or each printing substrate web, can be printed in a conventional manner with a printed image which is static and, therefore, identical for all printed copies. In web-fed printing presses designed as newspaper presses, offset printing units of this kind are positioned vertically one above the other as printing towers. In commercial web presses, the offset printing units are positioned horizontally one beside the other.

In web-fed printing presses, there is an increasing demand for further processing of printing substrate webs beyond mere conventional offset printing. This involves, for example, the use of printing technology to individualize printed copies, preferably by use of an inkjet printing device. Other possible processing beyond offset printing of printing substrate webs includes, e.g., gluing, coating, drying, or even stamping. In conventional web-fed printing presses, processing devices, which are used for processing printing substrate webs and are printed by using offset printing units, are positioned downstream of a folding apparatus as viewed in the transport direction of the printing substrate webs, i.e., where the production speed is slow.

While this has the advantage, in principle, that processing or post-processing of printing substrate webs printed by offset printing is not linked with the production speed of the offset printing units, a substantial drawback exists because not all of the printed pages, or not all of the areas inside a printed copy, are accessible to processing downstream of a folding apparatus.

For this reason, it is known to position processing devices downstream of the offset printing units and upstream of the folding apparatus of the web-fed printing press. However, to date there is no solution that allows printing substrate webs to be subjected to further processing beyond offset printing in a flexible manner within a web-fed printing press.

### SUMMARY OF THE INVENTION

It is therefore an object of the present invention to provide a web-fed printing press having at least one printing unit for static printing of at least one printing substrate web, preferably of a plurality of printing substrate webs, with a printed image which is invariable for all printed copies, and comprising at least one processing device positioned upstream of a folding apparatus, preferably for dynamic processing of at least one printing substrate web in a variable manner for at least some printed copies.

This and other objects and advantages are achieved in accordance with the invention by a web-fed printing press in which at least one processing device is supported at a manipulation device such that the processing device is displaceable by the manipulation device in three spatial dimensions within the region of action of the manipulation device and such that the processing device is positionable at a freely definable position of a printing substrate web and with a freely definable orientation to the printing substrate web.

The present invention advantageously provides the possibility to subject printing substrate webs, which are conventionally printed by printing units, to further processing in a flexible manner by at least one processing device such that every printing substrate web can be processed by a processing device in the area of every page, i.e., also in the area of the top side and bottom side of the page.

To this end, the processing device, or every processing device, is supported at a manipulation device, where the processing device is displaceable in the three spatial dimensions within the region of action of the manipulation device by the manipulation device at which the processing device is supported, i.e., such that the processing device is positionable at a freely definable position of a printing substrate web and with a freely definable orientation to the printing substrate web.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are described more fully with reference to the drawings without limiting the invention, in which:

FIG. 1 is an exemplary schematic diagram showing a side view of a web-fed printing press in accordance with the invention;

FIG. 2 is an exemplary schematic cross-sectional side view of the web-fed printing press along section II of FIG. 1;

FIG. 3 is an alternative exemplary cross-sectional schematic side view of the web-fed printing press along section II of FIG. 1; and

FIG. 4 is an alternative exemplary cross-sectional schematic side view of the web-fed printing press having a plurality of processing devices.

### DETAILED DESCRIPTION OF THE PREFERRED EMBODIMENTS

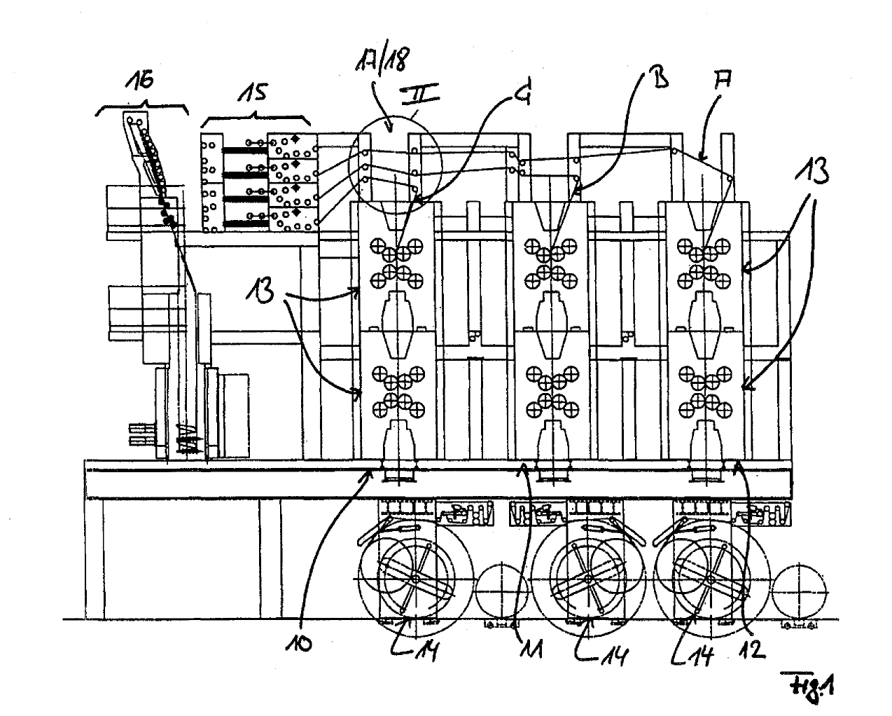

FIG. 1 is a schematic diagram of a web-fed printing press comprising a total of three printing towers 10, 11 and 12. Every printing tower 10, 11 and 12 includes two printing units 13 for offset printing which are positioned vertically one above the other, each of these printing units 13 being constructed as an H-type printing unit with four printing mechanisms. Printing substrate webs, i.e., printing substrate webs A, B and C in the present exemplary embodiment are printable on both sides in the area of the printing units 13.

The printing units 13 are preferably constructed as offset printing units to print the printing substrate webs A, B and C in a conventional manner with a static printed image which is therefore identical for all printed copies. The printing substrate webs A, B and C to be printed in the printing towers 10, 11 and 12 are supplied in the area of reel changers 14 and are fed to a folding apparatus 16 downstream of the printing towers 10, 11 and 12 by a turning unit 15. The person skilled in the art will be familiar with details concerning reel changers 14, turning units 15 and folding apparatus 16 so that more detailed descriptions are unnecessary.

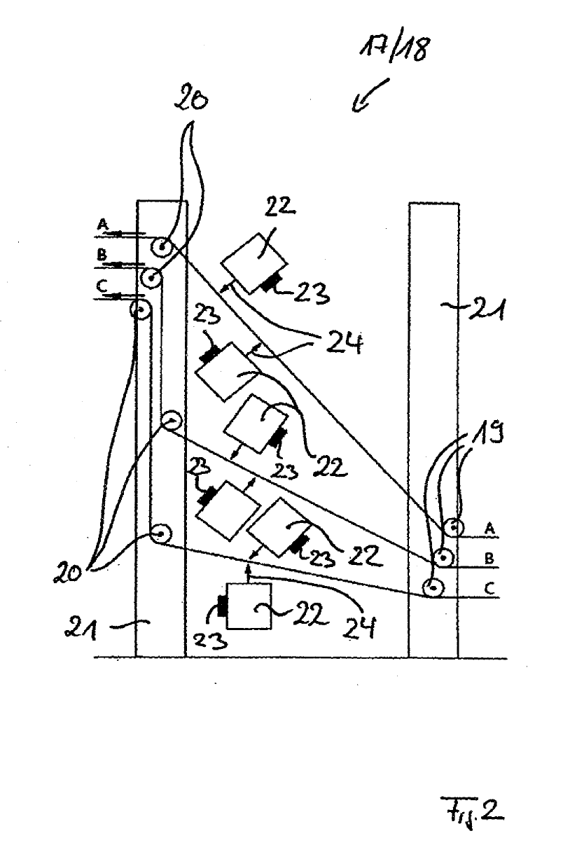

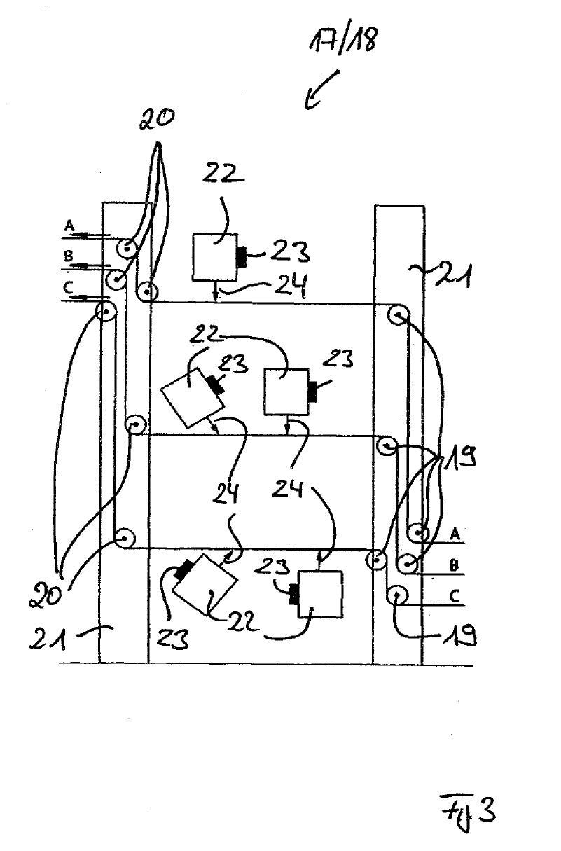

The printing press 10 comprises a web guiding device 18 at a defined position 17, i.e., as depicted in FIG. 1, above the top printing unit 13 of the printing tower 10. All of the printing substrate webs A, B and C printed in the printing units 13 are transportable through this web guiding device 18. The web guiding device 18 is shown only in a highly schematic manner in FIG. 1. FIGS. 2 and 3 show the web guiding device 18 in greater detail.

The web guiding device 18 of the web-fed printing press in accordance with the contemplated embodiments of the invention comprises a plurality of web guide rollers, i.e., a first quantity of web guide rollers 19 on the input side and a second quantity of web guide rollers 20 on the output side. The web guide rollers 19, 20 are rotatably supported at stationary side walls 21 or stationary frame parts. The printing substrate webs A, B and C can be introduced into the web guiding device 18 by the web guide rollers 19 on the input side and, conversely, the printing substrate webs A, B and C can be guided out of the web guiding device 18 by the web guide rollers 20 on the output side.

In the present exemplary embodiment, a processing device 22 is associated with the web-fed printing press in the area of the web guiding device 18. FIG. 2 shows the processing device in six different positions. FIG. 3 shows the processing device in five different positions.

The processing device 22 is supported at a manipulation device 23, such that the processing device 22 is displaceable in three spatial dimensions within the region of action of the manipulation device 23 by the manipulation device 23, i.e., such that the processing device 22 is positionable at a freely definable position of a printing substrate web A, B and C and with a freely definable orientation to the printing substrate web A, B and C.

Accordingly, as immediately appreciable from FIGS. 2 and 3, each of the printing substrate webs A, B and C can be processed by the processing device 22 in the area of a top side and a bottom side of the printing substrate web A, B and C. A processing direction of the processing device 22 indicated by arrows 24 encloses a freely definable angle with a top side or bottom side of the printing substrate web A, B and C to be processed.

As further appreciable from FIGS. 2 and 3, the printing substrate webs A, B and C are guided in the area of the web guiding device 18 such that a distance is adjusted between adjacent printing substrate webs A and B and B and C such that the processing device 22 is positionable by the manipulation device 23 between the adjacent printing substrate webs A and B and B and C so that both printing substrate webs A and B and B and C can be processed by the processing device 22 on the top and bottom sides. This also applies to the case illustrated in FIG. 2 in which the printing substrate webs A, B and C extend obliquely between the web guide rollers 19 on the input side and the web guide rollers 20 on the output side, as well as the case shown in FIG. 3 in which the printing substrate webs A, B and C are guided horizontally between the web guide rollers 19 on the input side and the web guide rollers 22 on the output side.

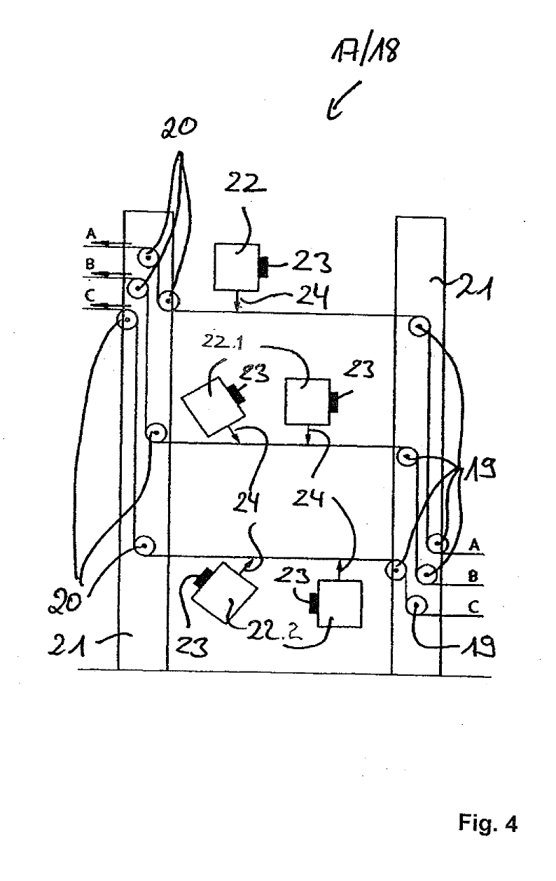

Although FIGS. 2 and 3 exclusively show one processing device 22 in different relative positions with respect to the printing substrate webs A, B and C, the web-fed printing press in accordance with the contemplated embodiments of the invention can also comprise a plurality of processing devices 22, where every processing device 22 is then supported at a manipulation device 23, respectively, such that the processing devices can be displaced in three dimensions by the manipulation devices, i.e., at a freely definable position with a freely definable orientation to a printing substrate web A, B and C. For example, FIG. 4 shows processing devices 22, 22.1, and 22.2 supported at manipulation devices 23, 23.1, and 23.2, respectively.

The processing device 22, or each processing device 22, is preferably a printing device for dynamic printing of the printing substrate webs A, B and C with a printed image which is variable and therefore changeable for at least some printed copies. The processing devices 22 are preferably constructed as inkjet printing devices. However, the processing device 22 can also be a gluing device, a coating device, a drying device, a foil transfer device, a cutting device, a perforating device, a stamping device, or any other processing device.

When there are a plurality of processing devices 22, 22.1, 22.2, as shown in FIG. 4, these processing devices 22, 22.1, 22.2 can be identical or different. In the case of identical processing devices, redundancy can be provided, such as, when maintenance work is being performed on one processing device a printing substrate web can be processed with the other processing device.

In accordance with a further advantageous embodiment of the present invention, the freely definable position of the processing device 22 relative to a printing substrate web A, B and C is adjustable depending on the transport speed of the printing substrate web A, B, C to be processed and depending on the processing speed of the processing device 22.

As a result, down time can be compensated at different speeds. Further, register adjustments can be performed in, or transverse to, the transport direction of the printing substrate web A, B and C.

Moreover, it is possible in the web-fed printing press in accordance with the contemplated embodiments of the invention to change the position and orientation of the processing device 22 relative to one of the printing substrate webs A, B and C to be processed during static printing of the printing substrate web A, B and C in the printing units 13. Accordingly, the position of the processing device 22 is changeable during the static printing of the printing substrate webs A, B and C. Additionally, the angular position of the processing direction of the processing device 22 relative to the respective printing substrate web A, B, C is changeable during the static printing of the respective printing substrate web A, B, C.

The manipulation device 23, at which a processing device 22 is supported and with which the processing device 22 is displaceable three-dimensionally in space within a region of action of the manipulation device 23, is preferably constructed as a robot arm, such as, of an industrial robot.

The manipulation device 23, together with the processing device 22 supported thereon, is preferably positioned in the area of the web guiding device 18 because, in the present exemplary embodiment, all of the printed printing substrate webs A, B and C are accessible in the area of the web guiding device 18. However, in contrast to this, it is also possible to position the manipulation device 22 together with the processing device 22 supported thereon at a different position inside the web-fed printing press at which, e.g., only printing substrate webs A and B are accessible.

The quantity of web guide rollers shown in the drawings and the quantity of printing substrate webs shown in the drawings are indicated purely by way of example. Further, the web guides shown in the drawings are intended purely as examples. The invention is applicable in newspaper printing presses and in commercial web presses having at least one printing unit.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A web-fed printing press, comprising:
at least one printing unit for static printing of at least one printing substrate web with a printed image which is invariable for all printed copies;
a folding apparatus; and
at least one processing device positioned upstream of the folding apparatus and configured to dynamically process the at least one printing substrate web in a variable manner for at least some printed copies; and
a manipulation device positioned to support the at least one processing device, the at least one processing device being displaceable by the manipulation device in three spatial dimensions within a region of action of the manipulation device such that the at least one processing device is positionable at a freely definable position of the at least one printing substrate web with a freely definable orientation to the at least one printing substrate web.

14. The web-fed printing press according to claim 13, wherein the at least one processing device is positionable by the manipulation device at any orientation to the at least one printing substrate web such that the processing direction of the at least one processing device encloses a freely definable angle with at least one of a top side and bottom side of the at least one printing substrate web.

15. Web-fed printing press according to claim 13, wherein the freely definable orientation of the at least one processing device relative to the at least one printing substrate web is adjustable depending on a transport speed of the at least one printing substrate web and a processing speed of the at least one processing device.

16. The web-fed printing press according to claim 13, wherein the manipulation device is constructed as a robot arm.

17. The web-fed printing press according to claim 13, wherein the at least one printing unit is configured as an offset printing unit and forms at least one printing tower of a newspaper printing press comprising a plurality of printing units positioned above one-another.

18. The web-fed printing press according to claim 14, wherein the at least one printing unit is configured as an offset printing unit and forms at least one printing tower of a newspaper printing press comprising a plurality of printing units positioned above one-another.

19. The web-fed printing press according to claim 15, wherein the at least one printing unit is configured as an offset printing unit and forms at least one printing tower of a newspaper printing press comprising a plurality of printing units positioned above one-another.

20. The web-fed printing press according to claim 13, wherein the at least one printing unit is configured as an offset printing unit and forms at least one printing section of a commercial web press comprising a plurality of printing units positioned beside one-another.

21. The web-fed printing press according to claim 14, wherein the at least one printing unit is configured as an offset printing unit and forms at least one printing section of a commercial web press comprising a plurality of printing units positioned beside one-another.

22. The web-fed printing press according to claim 15, wherein the at least one printing unit is configured as an offset printing unit and forms at least one printing section of a commercial web press comprising a plurality of printing units positioned beside one-another.

23. The web-fed printing press according to claim 13, wherein the at least one processing device is a printing device.

24. The web-fed printing press according to claim 23, wherein the printing device is an inkjet printing device.

25. The web-fed printing press according to claim 13, wherein the at least one processing device is one of a gluing device, a coating device, a drying device, a foil transfer device, a cutting device, a perforating device and a stamping device.

26. The web-fed printing press according to claim 13, wherein the manipulation device is positioned in an area of a web guiding device.

27. The web-fed printing press according to claim 26, wherein the web guiding device comprises a plurality of web guide rollers including a first quantity of web guide rollers for supplying each the at least one printing substrate web to the web guiding device and a second quantity of web guide rollers for removing each of the at least one printing substrate web from the web guiding device.

28. The web-fed printing press according to claim 26, the at least one substrate web comprises a plurality of printing substrate webs, the at least one processing device being positionable by the manipulation device between two of said plural printing substrate webs such that the processing device can process at least one of a top side and a bottom side of two of said plural printing substrate webs.

29. The web-fed printing press according to claim 27, wherein the web guiding device is stationary and is arranged downstream of the at least one printing unit and upstream of a turning unit as viewed in a transport direction of the at least one printing substrate web.

30. The web-fed printing press according to claim 26, wherein the web guiding device is stationary and is arranged downstream of the at least one printing unit and upstream of a turning unit as viewed in a transport direction of the at least one printing substrate web.

31. The web-fed printing press according to claim 13, wherein the at least one printing unit comprises a plurality of printing units static printing respectively a plurality of printing substrate webs, a web-guiding device receiving each of the printed plural printing substrate webs, the manipulation device being displaceable by the manipulation device each of said plural printing substrate webs.
